(19) United States
(12) Patent Application Publication
(10) Pub. No.: US 2026/0246715 A1
(43) Pub. Date: Aug. 20, 2026

(54) COMMUNICATION METHOD AND APPARATUS, AND STORAGE MEDIUM

(71) Applicant: BEIJING XIAOMI MOBILE SOFTWARE CO., LTD., Beijing (CN)

(72) Inventor: Qin MU, Beijing (CN)

(73) Assignee: BEIJING XIAOMI MOBILE SOFTWARE CO., LTD., Beijing (CN)

(21) Appl. No.: 19/469,588

(22) PCT Filed: Mar. 31, 2023
(86) PCT No.: PCT/CN2023/085808

§ 371 Date: Sep. 26, 2025

(51) Int. Cl. H04L 41/16; H04L 41/0803

(52) U.S. Cl. CPC H04L 41/16; H04L 41/0803

(57) ABSTRACT

The present disclosure relates to the technical field of communications, and relates to a communication method and apparatus, and a storage medium, for use in improving the communication performance of terminals. The method comprises: in response to a terminal switching from a first communication mode to a second communication mode, determining configuration information of the second communication mode.

### CROSS-REFERENCE TO RELATED APPLICATION

The application is a U.S. National Stage of International Application No. PCT/CN2023/085808 filed on Mar. 31, 2023, the entire content of which is incorporated herein by reference.

### TECHNICAL FIELD

The present disclosure relates to the technical field of communication, and in particular, to a communication method and apparatus, and a storage medium.

### BACKGROUND

In recent years, artificial intelligence (AI) technology has achieved continuous breakthroughs in various fields. In the related art, AI technology is introduced into the wireless air interface to assist in improving the transmission technology of the wireless air interface. Currently, the application of AI technology in the wireless air interface for communication processing is supported, including the training of AI models and the inference and application of models.

### SUMMARY

According to a first aspect of embodiments of the present disclosure, a communication method is provided, which is performed by a terminal. The method includes: in response to the terminal switching from a first communication mode to a second communication mode, determining configuration information of the second communication mode; where the first communication mode is a communication mode based on an artificial intelligence (AI) mode, and the second communication mode is a communication mode based on a non-AI mode.

According to a second aspect of the embodiments of the present disclosure, a communication method is provided, which is performed by a network device, and the method includes: determining configuration information of a second communication mode of a terminal, where the configuration information of the second communication mode is configuration information used by the terminal after the terminal switches from a first communication mode to the second communication mode, where the first communication mode is a communication mode based on an artificial intelligence (AI) mode, and the second communication mode is a communication mode based on a non-AI mode.

According to a third aspect of the embodiments of the present disclosure, a communication apparatus is provided, including: a processing module, configured to determine configuration information of a second communication mode in response to a terminal switching from a first communication mode to the second communication mode; where the first communication mode is a communication mode based on an artificial intelligence (AI) mode, and the second communication mode is a communication mode based on a non-AI mode.

According to the fourth aspect of the embodiments of the present disclosure, a communication apparatus is provided, including: a processing module, configured to determine configuration information of a second communication mode of a terminal, where the configuration information of the second communication mode is configuration information used by the terminal after the terminal switches from a first communication mode to the second communication mode; where the first communication mode is a communication mode based on an artificial intelligence (AI) mode, and the second communication mode is a communication mode based on a non-AI mode.

According to a fifth aspect of the embodiments of the present disclosure, a communication apparatus is provided, including: a processor; a memory, configured to store processor-executable instructions; where the processor is configured to: perform the communication method in the above-mentioned first aspect and the implementations of the first aspect.

According to a sixth aspect of the embodiments of the present disclosure, a communication apparatus is provided, including: a processor; a memory, configured to store processor-executable instructions; where the processor is configured to: perform the communication method in the above-mentioned second aspect and the implementations of the second aspect.

According to a seventh aspect of the embodiments of the present disclosure, a storage medium is provided, where instructions are stored in the storage medium, and the instructions in the storage medium, when executed by a processor of a terminal, enables the terminal to execute the communication method in the above-mentioned first aspect and the implementations of the first aspect.

According to an eighth aspect of the embodiments of the present disclosure, a storage medium is provided, where instructions are stored in the storage medium, and the instructions in the storage medium, when executed by a processor of a network device, enables the network device to execute the communication method in the above-mentioned second aspect and the implementations of the second aspect.

It is to be understood that the foregoing general description and the following detailed description are exemplary and explanatory only, and do not limit the present disclosure.

### BRIEF DESCRIPTION OF THE DRAWINGS

The accompanying drawings herein, which are incorporated in and constitute a part of the specification, illustrate embodiments consistent with the present disclosure and are used in conjunction with the specification to explain principles of the present disclosure.

FIG. 1 is a schematic diagram of a wireless communication system shown according to an embodiment.

FIG. 2 is a flow chart of a communication method shown according to an embodiment.

FIG. 3 is a flow chart of a communication method shown according to an embodiment.

FIG. 4 is a flow chart of a communication method shown according to an embodiment.

FIG. 5 is a flow chart of a communication method shown according to an embodiment.

FIG. 6 is a flow chart of a communication method shown according to an embodiment.

FIG. 7 is a flow chart of a communication method shown according to an embodiment.

FIG. 8 is a flow chart of a communication method shown according to an embodiment.

FIG. 9 is a flow chart of a communication method shown according to an embodiment.

FIG. 10 is a flow chart of a communication method shown according to an embodiment.

FIG. 11 is a flow chart of a communication method shown according to an embodiment.

FIG. 12 is a block diagram of a communication apparatus shown according to an embodiment.

FIG. 13 is a block diagram of a communication apparatus shown according to an embodiment.

FIG. 14 is a block diagram of a communication apparatus shown according to an embodiment.

FIG. 15 is a block diagram of a communication apparatus shown according to an embodiment.

### DETAILED DESCRIPTION

Embodiments are described in detail herein, examples of which are represented in the accompanying drawings. When the following description relates to the drawings, the same numerals in different accompanying drawings represent the same or similar elements unless otherwise indicated. The implementations described in the following embodiments do not represent all implementations consistent with the embodiments of the present disclosure.

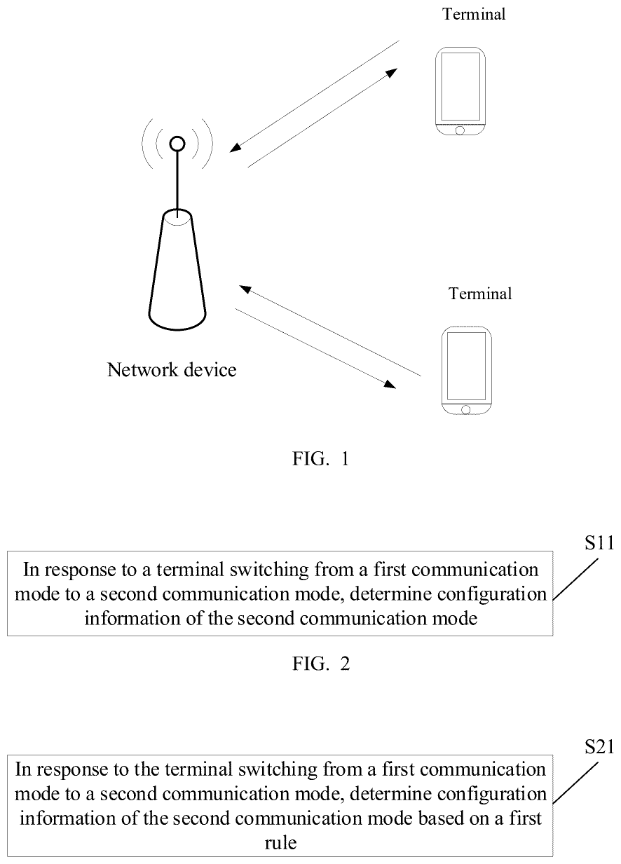

The communication method provided in the embodiments of the present disclosure may be applied to the wireless communication system shown in FIG. 1. Referring to FIG. 1, the wireless communication system includes a network device and a terminal. The terminal is connected to the network device via wireless resources and performs data transmission.

It should be understood that the wireless communication system shown in FIG. 1 is for illustrative purposes only, and the wireless communication system may also include other network devices, such as core network devices, wireless relay devices, and wireless backhaul devices, which are not shown in FIG. 1. The embodiments of the present disclosure do not limit the number of network devices and terminals included in the wireless communication system.

It should be further understood that the wireless communication system in the embodiments of the present disclosure is a network that provides wireless communication functions. A wireless communication system may adopt different communication technologies, such as code division multiple access (CDMA), wideband code division multiple access (WCDMA), time division multiple access (TDMA), frequency division multiple access (FDMA), orthogonal frequency-division multiple access (OFDMA), single Carrier FDMA (SC-FDMA), and Carrier Sense Multiple Access with Collision Avoidance. Networks can be classified into 2G (generation) networks, 3G networks, 4G networks, or future evolved networks such as 5G networks according to factors like network capacity, speed, and delay. 5G networks may also be referred to as New Radio (NR) networks. For the convenience of description, the present disclosure may sometimes abbreviate the wireless communication network as a “network”.

Further, the network device involved in the present disclosure may also be referred to as a radio access network device. The radio access network device may be: a base station, an evolved node B (base station), a home base station, an access point (AP) in a wireless fidelity (WIFI) system, a wireless relay node, a wireless backhaul node, a transmission point (TP), a transmission and reception point (TRP), etc. It may also be a gNB in an NR system, or a component or part of a device constituting a base station, etc. It should be understood that the embodiments of the present disclosure do not limit the specific technology and specific device form adopted by the network device. In the present disclosure, a network device can provide communication coverage for a specific geographical area and can communicate with terminals located within the coverage area (cell). In addition, when it is a vehicle-to-everything (V2X) communication system, the network device can also be a vehicle-mounted device.

Further, the terminal involved in the disclosure may also be referred to as a terminal device, a user equipment (UE), a mobile station (MS), a mobile terminal (MT), etc., which is a device that provides voice and/or data connectivity for a user. For instance, the terminal may be a handheld device, a vehicle-mounted device, etc., with a wireless connection function. At present, some instances of the terminal include a mobile phone, a customer premises equipment, a pocket personal computer (PPC), a palm computer, a personal digital assistant (PDA), a laptop computer, a tablet computer, a wearable device, and a vehicle-mounted device. In addition, in a case of a vehicle-to-everything (V2X) communication system, the terminal device may be a vehicle-mounted device. It should be understood that in the embodiments of the present disclosure, specific technologies and specific device forms used for the terminal are not limited.

In recent years, artificial intelligence (AI) technology has achieved continuous breakthroughs in numerous fields. The continued development of fields like intelligent voice and computer vision has not only brought a rich variety of applications to smart terminals, but has also found widespread application in education, transportation, home living, healthcare, retail, security, and other fields. This has brought convenience to people's lives while also promoting industrial upgrades across various industries. AI technology is also rapidly interpenetrating with other disciplines, integrating knowledge from diverse disciplines while also providing new directions and methods for their development.

In related art, a research project on AI technology in the radio access network (RAN) has been established to introduce artificial intelligence technology into the wireless air interface to assist in improving wireless air interface transmission technology. Furthermore, the application of AI technology in the wireless air interface for communication processing, including AI model training and model inference applications, is currently supported.

In some embodiments, AI models are introduced for functions such as Channel State Information (CSI), beam management, and positioning. For example, CSI is compressed or predicted based on the AI model, and optimal beam is predicted based on AI model. However, in the AI communication mode, due to the influence of the generalization ability of AI models, and since AI models cannot work well under all configurations and in all environments, it is necessary to monitor the operation of AI models in the AI communication mode.

In some embodiments, when the performance of the AI model is found to be degraded, the terminal may fall back to the traditional non-AI communication mode for processing.

Therefore, how to determine the traditional non-AI communication mode that is suitable for the current environment is a problem that needs to be solved.

Based on the above problem, an embodiment of the present disclosure provides a communication method, which determines the configuration information of the non-AI communication mode when a terminal needs to switch from the AI communication mode to the non-AI communication mode, thereby improving the switching efficiency and the communication performance of the terminal.

FIG. 2 is a flow chart of a communication method shown according to an embodiment. As shown in FIG. 2, the communication method is executed by a terminal and includes the following steps.

In step S11, in response to the terminal switching from a first communication mode to a second communication mode, configuration information of the second communication mode is determined.

In some embodiments, switching may also be understood as fallback.

In some embodiments, the first communication mode is an AI communication mode, and the second communication mode is a non-AI communication mode.

In some embodiments, the AI communication mode can be understood as a processing mode for communication based on an AI model, and the non-AI mode can be understood as a processing mode for communication not based on an AI model. For example, in the AI communication mode, the terminal may use the AI model for positioning; in the non-AI communication mode, the terminal may use a traditional algorithm (such as TDOA) for positioning.

In some embodiments, the scenarios of the first communication mode are different, and the configuration information of the second communication mode is different.

For example, the scenario of the first communication mode is an AI-based positioning scenario, and the configuration information of the second communication mode includes which traditional positioning mode the terminal uses, such as TDOA or Multi-RTT. If TDOA is used, the configuration information includes the reference signal used for positioning and the relevant configuration of the network device used for positioning.

As another example, the scenario of the first communication mode is an AI-based beam management scenario, and the configuration information of the second communication mode may include the specific configuration information of RS and the information to be fed back by the terminal.

In some embodiments, the terminal is capable of communicating based on the configuration information of the second communication mode.

For example, in a positioning scenario, the second configuration information configures the terminal to use the TDOA algorithm for positioning, and the terminal performs positioning based on the TDOA algorithm and other relevant configuration information.

In an embodiment of the present disclosure, when a terminal needs to switch from a first communication mode to a second communication mode, configuration information of the second communication mode is determined, and communication is performed based on the determined configuration information, thereby improving switching efficiency and communication performance of the terminal.

In a communication method provided by an embodiment of the present disclosure, a terminal may determine configuration information of a second communication mode based on a first rule.

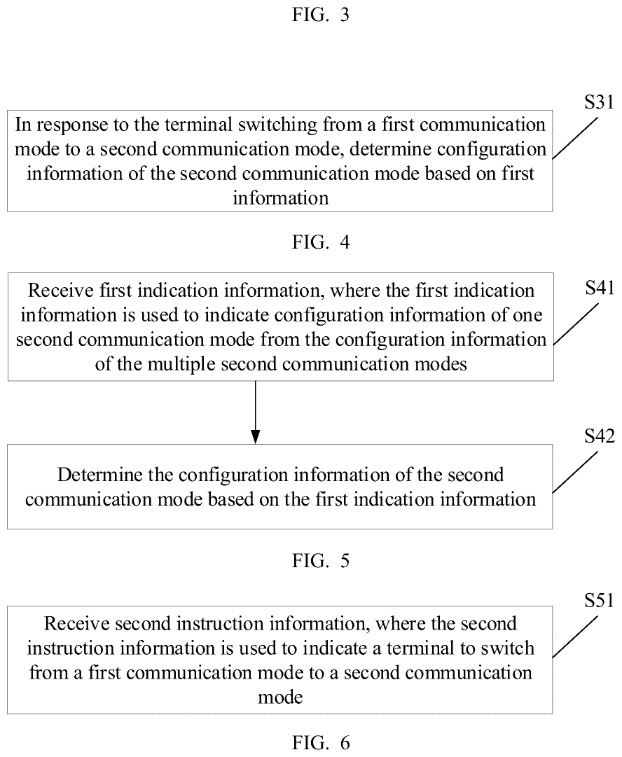

FIG. 3 is a flow chart of a communication method shown according to an embodiment. As shown in FIG. 3, the method includes the following steps.

In step S21, in response to the terminal switching from a first communication mode to a second communication mode, configuration information of the second communication mode is determined based on a first rule.

In some embodiments, the first rule may be a protocol specification. Optionally, the configuration information of the second communication mode is determined based on the protocol specification.

In some embodiments, the first rule includes at least one of the following:
the configuration information of the second communication mode is the configuration information of the second communication mode before the terminal enters the first communication mode; and
the configuration information of the second communication mode is the configuration information of the second communication mode when the terminal accesses the network device.

In some embodiments, the first rule is that the configuration information of the second communication mode is the configuration information of the second communication mode before the terminal enters the first communication mode.

For example, in a positioning scenario, the second communication mode before the terminal enters the first communication mode is the TDOA algorithm. The configuration information for the second communication mode includes the reference signal used for positioning and the network device used for positioning. After the terminal switches from the first communication mode to the second communication mode, positioning is performed based on the reference signal used for positioning under the TDOA algorithm and the network device used for positioning.

In some embodiments, the first rule is that the configuration information of the second communication mode is the configuration information of the second communication mode when the terminal accesses the network device.

For example, still taking the positioning scenario as an example, if the second communication mode when the terminal accesses the network device is the TDOA algorithm, then the configuration information of the second communication mode includes the reference signal used for positioning and the network device used for positioning. Then, after the terminal switches from the first communication mode to the second communication mode, positioning is performed based on the reference signal used for positioning and the network device used for positioning under the TDOA algorithm.

In some embodiments, the first rule includes that the configuration information of the second communication mode is the configuration information of the second communication mode before the terminal enters the first communication mode, and the configuration information of the second communication mode is the configuration information of the second communication mode when the terminal accesses the network device. Then, when the terminal switches from the first communication mode to the second communication mode, it determines by itself whether to communicate based on the configuration information of the second communication mode before the terminal enters the first communication mode or based on the configuration information of the second communication mode when the terminal accesses the network device.

For example, the terminal compares, based on historical information, the communication quality when communicating based on the configuration information of the second communication mode before entering the first communication mode with the communication quality when communicating based on the configuration information of the second communication mode when accessing the network device, and selects the configuration information with higher communication quality for communication.

In the embodiment of the present disclosure, the terminal determines the configuration information of the second communication mode based on the first rule, and communicates based on the determined configuration information, thereby improving switching efficiency and communication performance of the terminal.

In a communication method provided by an embodiment of the present disclosure, a terminal determines configuration information of a second communication mode based on first information.

FIG. 4 is a flow chart of a communication method shown according to an embodiment. As shown in FIG. 4, the method includes the following steps.

In step S31, in response to the terminal switching from a first communication mode to a second communication mode, configuration information of the second communication mode is determined based on first information.

In some embodiments, the first information is preconfigured by a network device. In some embodiments, the terminal receives the first information sent by the network device and determines the configuration information of the second communication mode based on the first information. Of course, the first information may also be preconfigured by other devices, and the embodiments of the present disclosure are not limited thereto.

In some embodiments, the first information includes at least one of the following:
configuration information of a single second communication mode; and
configuration information of multiple second communication modes.

In some embodiments, the first information is configuration information of a single second communication mode pre-configured by the network device.

In the embodiment of the present disclosure, the network device pre-configures the configuration information of a single second communication mode. When the terminal switches from the first communication mode to the second communication mode, communication is performed based on the configuration information of the single second communication mode pre-configured by the network device.

In some embodiments, the first information is configuration information of multiple second communication modes pre-configured by the network device.

In some embodiments, configuration information of different second communication modes among the multiple second communication modes are different.

In a communication method provided by an embodiment of the present disclosure, configuration information of a second communication mode used when a terminal switches from a first communication mode to a second communication mode is determined based on first indication information.

FIG. 5 is a flow chart of a communication method shown according to an embodiment. As shown in FIG. 5, the method includes the following steps.

In step S41, first indication information is received, where the first indication information is used to indicate configuration information of one second communication mode from the configuration information of the multiple second communication modes.

In some embodiments, the first indication information may be carried in higher-layer signaling, such as radio resource control (RRC) signaling.

In step S42, the configuration information of the second communication mode is determined based on the first indication information.

In an embodiment of the present disclosure, when the first information includes configuration information of multiple second communication modes, first indication information is received, and the configuration information of the second communication mode to be used is determined based on the first indication information.

In a communication method provided by an embodiment of the present disclosure, when the terminal determines to switch from the first communication mode to the second communication mode based on indication information of the network device, the indication information may be first indication information.

For example, the first indication information is used to indicate the terminal to switch from the first communication mode to the second communication mode, and the bit overhead of the first indication information is 2 bits, the first bit is used to indicate the terminal to switch to a second communication mode 1, and the second bit is used to indicate the terminal to switch to a second communication mode 2.

In an embodiment of the present disclosure, when configuration information of multiple second communication modes are pre-configured in the first information, the terminal determines to switch from the first communication mode to the second communication mode based on the first indication information, and determines the configuration information of the second communication mode used by the terminal from the configuration information of multiple second communication modes based on the first indication information.

In a communication method provided by an embodiment of the present disclosure, when the terminal determines to switch from the first communication mode to the second communication mode based on indication information of the network device, the indication information may be second indication information.

FIG. 6 is a flow chart of a communication method shown according to an embodiment. As shown in FIG. 6, the method includes the following steps.

In step S51, second instruction information is received, where the second instruction information is used to indicate a terminal to switch from a first communication mode to a second communication mode.

In some embodiments, the second indication information may be carried in higher-layer signaling, such as RRC.

In an embodiment of the present disclosure, the terminal determines to switch from the first communication mode to the second communication mode based on the second indication information, and determines the configuration information of the second communication mode based on a first rule or first information.

For example, the terminal determines to switch from the first communication mode to the second communication mode based on the second indication information, and determines the configuration information of the second communication mode based on the first rule.

For another example, the network device preconfigures configuration information of a single second communication mode, the terminal determines to switch from the first communication mode to the second communication mode based on the second indication information, and determines the configuration information of the second communication mode based on the pre-configuration of the network device.

For another example, the network device preconfigures configuration information of multiple second communication modes, the terminal determines to switch from the first communication mode to the second communication mode based on second indication information, and determines the configuration information of the second communication mode based on the first indication information.

In a communication method provided by an embodiment of the present disclosure, a terminal determines that a preset condition is satisfied and determines to switch from a first communication mode to a second communication mode.

In some embodiments, the preset condition may be that the rate of decrease of the inference performance of the AI mode in the first communication mode exceeds a rate threshold, the accuracy of the inference performance of the AI model in the first communication mode is lower than an accuracy threshold, and so on.

In the embodiment of the present disclosure, when the terminal determines that the preset condition is met, it determines to switch from the first communication mode to the second communication mode without waiting for instructions from the network device, thereby improving switching efficiency and communication performance of the terminal.

In a communication method provided by an embodiment of the present disclosure, a terminal determines to switch from a first communication mode to a second communication mode based on third indication information, and simultaneously determines configuration information of the second communication mode based on the third indication information.

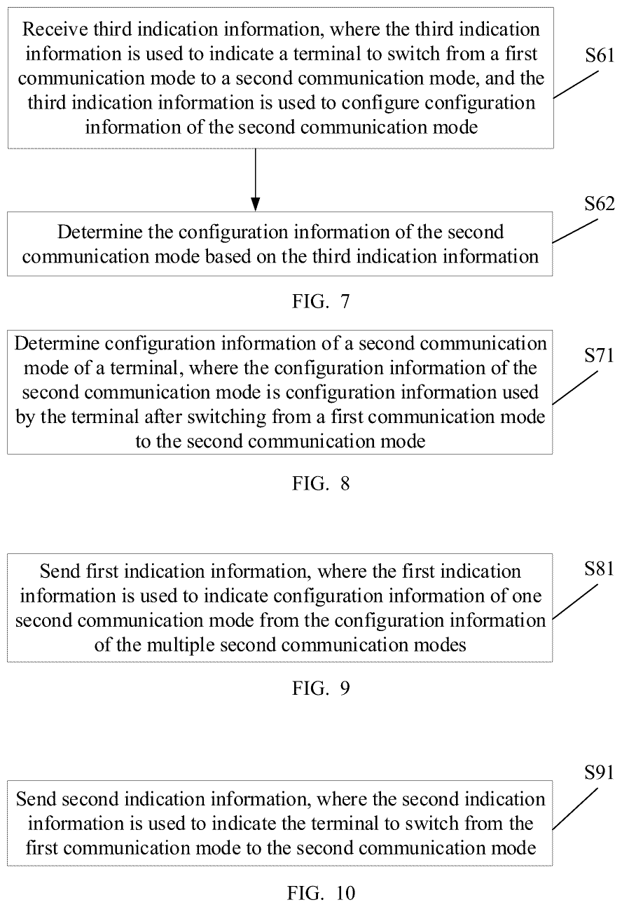

FIG. 7 is a flow chart of a communication method shown according to an embodiment. As shown in FIG. 7, the method includes the following steps.

In step S61, third indication information is received, where the third indication information is used to indicate a terminal to switch from a first communication mode to a second communication mode, and the third indication information is used to configure configuration information of the second communication mode.

In step S62, the configuration information of the second communication mode is determined based on the third indication information.

In some embodiments, the third indication information is carried in physical layer signaling or higher-layer signaling.

In some embodiments, the terminal is indicated to switch from the first communication mode to the second communication mode based on the physical layer signaling, and the configuration information of the second communication mode is configured based on the physical layer signaling.

In some embodiments, the terminal is indicated to switch from the first communication mode to the second communication mode based on the higher-layer signaling, and the configuration information of the second communication mode is configured based on the higher-layer signaling.

In the embodiments of the present disclosure, switching from a first communication mode to a second communication mode is determined based on third indication information, and at the same time, configuration information of the second communication mode is determined based on the third indication information. Then, communication is performed based on the configuration information of the second communication mode, thereby improving switching efficiency and communication performance of the terminal.

In a communication method provided by an embodiment of the present disclosure, the third indication information is used to configure first configuration information of the second communication mode.

In some embodiments, the terminal determines the configuration information of the second communication mode based on the first configuration information and the second configuration information, where the second configuration information is pre-configured by the network device.

In some embodiments, the first configuration information is carried in physical layer signaling, and the second configuration information is carried in high layer signaling.

In the embodiments of the present disclosure, the terminal determines the second configuration information of the second communication mode based on the higher-layer signaling, and when receiving the third indication information sent through the physical layer signaling, determines to switch from the first communication mode to the second communication mode based on the third indication information, and at the same time determines the first configuration information of the second communication mode based on the third indication information, and then communicates based on the first configuration information and the second configuration information, thereby improving switching efficiency and communication performance of the terminal.

FIG. 8 is a flow chart of a communication method shown according to an embodiment. As shown in FIG. 8, the communication method is executed by a network device and includes the following steps.

In step S71, configuration information of a second communication mode of a terminal is determined, where the configuration information of the second communication mode is configuration information used after the terminal switches from a first communication mode to the second communication mode.

In some embodiments, switching may also be understood as fallback.

In some embodiments, the first communication mode is an AI communication mode, and the second communication mode is a non-AI communication mode.

In some embodiments, the AI communication mode can be understood as a processing mode for communication based on an AI model, and the non-AI mode can be understood as a processing mode for communication not based on an AI model. For example, in the AI communication mode, the terminal can use the AI model for positioning; in the non-AI communication mode, the terminal can use a traditional algorithm (such as TDOA) for positioning.

In some embodiments, the scenarios of the first communication mode are different, and the configuration information of the second communication mode is different.

For example, the scenario of the first communication mode is an AI-based positioning scenario, and the configuration information of the second communication mode includes which traditional positioning mode the terminal uses, such as TDOA or Multi-RTT. If TDOA is used, the configuration information includes the reference signal used for positioning and the relevant configuration of the network device used for positioning.

As another example, the scenario of the first communication mode is an AI-based beam management scenario, and the configuration information of the second communication mode may include the specific configuration information of RS and the information to be fed back by the terminal.

In an embodiment of the present disclosure, configuration information of a second communication mode of a terminal is determined. The configuration information of the second communication mode is the configuration information used by the terminal after switching from a first communication mode to the second communication mode, so that the terminal can communicate based on the configuration information of the second communication mode, thereby improving switching efficiency and communication performance of the terminal.

In a communication method provided by an embodiment of the present disclosure, configuration information of a second communication mode is determined based on a first rule.

In some embodiments, the first rule may be a protocol specification. Optionally, the configuration information of the second communication mode is determined based on the protocol specification.

In some embodiments, the first rule includes at least one of the following:
the configuration information of the second communication mode being the configuration information of the second communication mode before the terminal enters the first communication mode; and
the configuration information of the second communication mode being the configuration information of the second communication mode when the terminal accesses the network device.

In some embodiments, the first rule is that the configuration information of the second communication mode is the configuration information of the second communication mode before the terminal enters the first communication mode.

For example, in a positioning scenario, the second communication mode before the terminal enters the first communication mode is a TDOA algorithm. The configuration information for the second communication mode includes the reference signal used for positioning and the network device used for positioning. After the network device determines that the terminal has switched from the first communication mode to the second communication mode, the terminal performs positioning based on the reference signal used for positioning under the TDOA algorithm and the network device used for positioning.

In some embodiments, the first rule is that the configuration information of the second communication mode is the configuration information of the second communication mode when the terminal accesses the network device.

For example, still taking the positioning scenario as an example, if the second communication mode when the terminal accesses the network device is the TDOA algorithm, then the configuration information for the second communication mode includes the reference signal used for positioning and the network device used for positioning. Then, after the network device determines that the terminal has switched from the first communication mode to the second communication mode, it performs positioning based on the reference signal used for positioning and the network device used for positioning under the TDOA algorithm.

In a communication method provided by an embodiment of the present disclosure, a network device determines configuration information of a second communication mode based on first information.

In some embodiments, the first information includes at least one of the following:
configuration information of a single second communication mode; and
configuration information of multiple second communication modes.

In some embodiments, the first information is configuration information of a single second communication mode pre-configured by the network device.

In the embodiment of the present disclosure, the network device pre-configures configuration information of a single second communication mode. When the terminal switches from the first communication mode to the second communication mode, the terminal may communicate based on the configuration information of the single second communication mode pre-configured by the network device.

In some embodiments, the first information is configuration information of multiple second communication modes pre-configured by the network device.

In some embodiments, configuration information of different second communication modes among multiple second communication modes are different.

In a communication method provided by an embodiment of the present disclosure, first indication information is sent, where the first indication information is used to indicate configuration information of one second communication mode from configuration information of the multiple second communication modes.

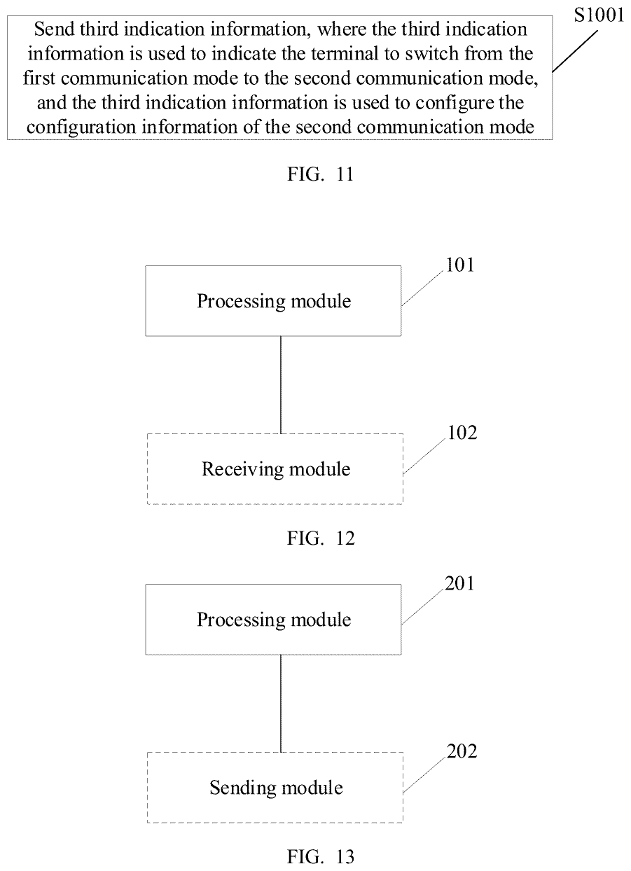

FIG. 9 is a flow chart of a communication method shown according to an embodiment. As shown in FIG. 9, the method includes the following steps.

In step S81, first indication information is sent, where the first indication information is used to indicate configuration information of one second communication mode from the configuration information of the multiple second communication modes.

In some embodiments, the first indication information may be carried in higher-layer signaling, such as radio resource control signaling (RRC).

In the embodiment of the present disclosure, when the first information includes configuration information of the multiple second communication modes, first indication information is sent, and the configuration information of the second communication mode to be used is determined through the first indication information.

In a communication method provided by an embodiment of the present disclosure, when a network device indicates a terminal to switch from a first communication mode to a second communication mode, the instruction information may be first instruction information.

For example, the first indication information is used to indicate the terminal to switch from the first communication mode to the second communication mode, and the bit overhead of the first indication information is 2 bits, the first bit is used to indicate the terminal to switch to a second communication mode 1, and the second bit is used to indicate the terminal to switch to a second communication mode 2.

In an embodiment of the present disclosure, when configuration information of multiple second communication modes is pre-configured in the first information, the network device sends first indication information to indicate the terminal to switch from the first communication mode to the second communication mode, and based on the first indication information, the terminal determines the configuration information of the second communication mode used by the terminal from the configuration information of the multiple second communication modes.

In a communication method provided by an embodiment of the present disclosure, when the network device indicates the terminal to switch from the first communication mode to the second communication mode, the instruction information may be second instruction information.

FIG. 10 is a flow chart of a communication method shown according to an embodiment. As shown in FIG. 10, the method includes the following steps.

In step S91, second indication information is sent, where the second indication information is used to indicate the terminal to switch from the first communication mode to the second communication mode.

In some embodiments, the second indication information may be carried in higher-layer signaling, such as RRC.

In a communication method provided by an embodiment of the present disclosure, a network device sends third indication information to indicate a terminal to switch from a first communication mode to a second communication mode, and at the same time indicates the terminal to determine configuration information of the second communication mode based on the third indication information.

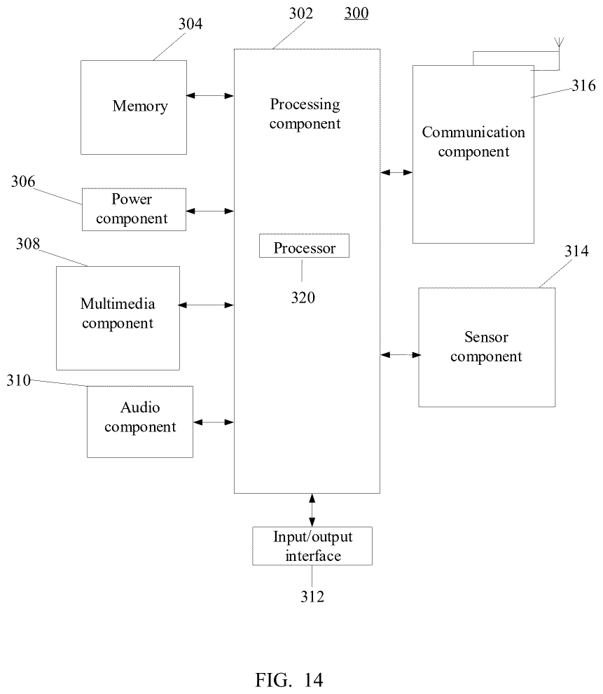

FIG. 11 is a flow chart of a communication method shown according to an embodiment. As shown in FIG. 11, the method includes the following steps.

In step S1001, third indication information is sent, where the third indication information is used to indicate the terminal to switch from the first communication mode to the second communication mode, and the third indication information is used to configure the configuration information of the second communication mode.

In some embodiments, the third indication information is carried in physical layer signaling or higher-layer signaling.

In some embodiments, the terminal is indicated to switch from the first communication mode to the second communication mode based on the physical layer signaling, and the configuration information of the second communication mode is configured based on the physical layer signaling.

In some embodiments, the terminal is indicated to switch from the first communication mode to the second communication mode based on the higher-layer signaling, and the configuration information of the second communication mode is configured based on the higher-layer signaling.

In an embodiment of the present disclosure, the terminal is indicated to switch from the first communication mode to the second communication mode based on the third indication information, and at the same time, the terminal is indicated to determine the configuration information of the second communication mode based on the third indication information, so that the terminal can communicate based on the configuration information of the second communication mode, thereby improving the switching efficiency and the communication performance of the terminal.

In a communication method provided by an embodiment of the present disclosure, the third indication information is used to configure first configuration information of the second communication mode.

In some embodiments, the network device pre-configures second configuration information of the second communication mode.

In some embodiments, the terminal is capable of determining the configuration information of the second communication mode based on the first configuration information and the second configuration information.

In some embodiments, the first configuration information is carried in physical layer signaling, and the second configuration information is carried in high layer signaling.

In the embodiments of the present disclosure, the network device configures the second configuration information of the second communication mode for the terminal based on the higher-layer signaling. When sending the third indication information, the third indication information is used to indicate the terminal to determine to switch from the first communication mode to the second communication mode. At the same time, the third indication information is used to indicate the terminal to determine the first configuration information of the second communication mode, thereby enabling the terminal to communicate based on the first configuration information and the second configuration information, thereby improving switching efficiency and communication performance of the terminal.

It should be noted that those skilled in the art may appreciate that the various implementation methods/embodiments involved in the embodiments of the present disclosure can be used in conjunction with the aforementioned embodiments or can be used independently. Whether used alone or in conjunction with the aforementioned embodiments, the implementation principles are similar. In the implementation of the present disclosure, some embodiments are described in terms of implementation methods used together. Of course, those skilled in the art will appreciate that such examples are not limitations on the embodiments of the present disclosure.

Based on the same concept, an embodiment of the present disclosure further provides a communication apparatus.

It is understandable that the communication apparatus provided by the embodiment of the present disclosure includes hardware structures and/or software modules corresponding to the execution of each function in order to realize the above functions. In combination with the units and algorithm steps of each example disclosed in the embodiment of the present disclosure, the embodiment of the present disclosure can be implemented in the form of hardware or a combination of hardware and computer software. Whether a function is executed in the form of hardware or computer software driving hardware depends on the specific application and design constraints of the technical solution. Those skilled in the art can use different methods to implement the described functions for each specific application, but such implementation should not be considered to exceed the scope of the technical solution of the embodiment of the present disclosure.

FIG. 12 is a block diagram of a communication apparatus shown according to an embodiment. Referring to FIG. 12, the apparatus includes a processing module 101.

The processing module 101 is configured to determine configuration information of a second communication mode in response to a terminal switching from a first communication mode to the second communication mode.

In one embodiment, the first communication mode is a communication mode based on an artificial intelligence (AI) mode, and the second communication mode is a communication mode based on a non-AI mode.

In one implementation, the processing module 101 is configured to determine the configuration information of the second communication mode based on a first rule.

The first rule includes at least one of the following: the configuration information of the second communication mode being the configuration information of the second communication mode before the terminal enters the first communication mode; and the configuration information of the second communication mode being the configuration information of the second communication mode when the terminal accesses the network device.

In one implementation, the processing module 101 is configured to determine the configuration information of the second communication mode based on first information.

The first information includes at least one of the following:
configuration information of a single second communication mode; and
configuration information of multiple second communication modes.

In one implementation, the processing module 101 is configured to receive first indication information, where the first indication information is used to indicate configuration information of one second communication mode from the configuration information of the multiple second communication modes; and determine the configuration information of the second communication mode based on the first indication information.

In one implementation, the first indication information is further used to indicate the terminal to switch from the first communication mode to the second communication mode.

In one implementation the apparatus further includes a receiving module 102. The receiving module 102 is configured to receive second indication information, where the second indication information is used to indicate the terminal to switch from the first communication mode to the second communication mode.

In one implementation, the processing module 101 is used to: receive third indication information, where the third indication information is used to indicate the terminal to switch from the first communication mode to the second communication mode, and the third indication information is used to configure configuration information of the second communication mode; and determine the configuration information of the second communication mode based on the third indication information.

In one implementation, the third indication information is used to configure first configuration information of the second communication mode.

In one implementation, the processing module 101 is configured to determine the configuration information of the second communication mode based on first configuration information and second configuration information, where the second configuration information is pre-configured by the network device.

In one implementation, the first configuration information is carried in physical layer signaling, and the second configuration information is carried in higher-layer signaling.

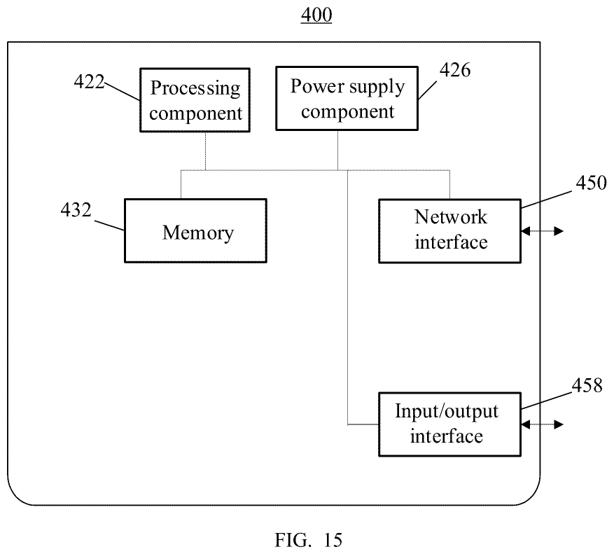

FIG. 13 is a block diagram of a communication apparatus shown according to an embodiment. Referring to FIG. 13, the apparatus includes a processing module 201.

The processing module 201 is configured to determine configuration information of a second communication mode of a terminal, where the configuration information of the second communication mode is configuration information used after the terminal switches from a first communication mode to the second communication mode.

In one implementation, the first communication mode is a communication mode based on an artificial intelligence (AI) mode, and the second communication mode is a communication mode based on a non-AI mode.

In one implementation, the processing module 201 is configured to determine the configuration information of the second communication mode based on a first rule.

The first rule includes at least one of the following: the configuration information of the second communication mode is the configuration information of the second communication mode before the terminal enters the first communication mode; and the configuration information of the second communication mode is the configuration information of the second communication mode when the terminal accesses the network device.

In one implementation, the processing module 201 is configured to determine the configuration information of the second communication mode based on first information.

The first information includes at least one of the following:
configuration information of a single second communication mode; and
configuration information of multiple second communication modes.

In one implementation, the apparatus further includes a sending module 202. The sending module 202 is configured to send first indication information, where the first indication information is used to indicate configuration information of one second communication mode from the configuration information of multiple second communication modes.

In one implementation, the first indication information is further used to indicate the terminal to switch from the first communication mode to the second communication mode.

In one implementation, the sending module 202 is configured to send second indication information, where the second indication information is used to indicate the terminal to switch from the first communication mode to the second communication mode.

In one implementation, the sending module 202 is configured to send third indication information, where the third indication information is used to indicate the terminal to switch from the first communication mode to the second communication mode, and the third indication information is used to configure the configuration information of the second communication mode.

In one implementation, the third indication information is used to configure first configuration information of the second communication mode.

In one implementation, the network device pre-configures second configuration information of the second communication mode.

In one implementation, the first configuration information is carried in physical layer signaling, and the second configuration information is carried in higher-layer signaling.

Regarding the apparatus in the above embodiments, the specific manners in which each module performs operations have been described in detail in the embodiments related to the method, and will not be elaborated herein.

The technical solutions provided by the embodiments of the present disclosure may have the following beneficial effects: when a terminal needs to switch from a first communication mode to a second communication mode, configuration information of the second communication mode is determined. Thus, when the terminal needs to switch the communication mode, the configuration information of the second communication mode can be quickly determined, enabling communication based on the determined configuration information, thereby improving the communication performance of the terminal.

FIG. 14 is a block diagram of a communication apparatus shown according to an embodiment. For example, the apparatus 300 may be a mobile phone, a computer, a digital broadcasting terminal, a message receiving and transmitting device, a game console, a tablet device, a medical device, a fitness device, or a personal digital assistant, etc.

Referring to FIG. 14, the apparatus 300 may include one or more of the following components: a processing component 302, a memory 304, a power component 306, a multimedia component 308, an audio component 310, an input/output (I/O) interface 312, a sensor component 314, and a communication component 316.

The processing component 302 typically controls overall operation of the apparatus 300, such as the operations associated with display, telephone calls, data communications, camera operations, and recording operations. The processing component 302 may include one or more processors 320 to execute instructions to complete all or part of the steps of the above-described methods. Moreover, the processing component 302 may include one or more modules which facilitate the interaction between the processing component 302 and other components. For instance, the processing component 302 may include a multimedia module to facilitate the interaction between the multimedia component 308 and the processing component 302.

The memory 304 is configured to store various types of data to support the operation of the apparatus 300. Examples of such data include instructions for any applications or methods operated on the apparatus 300, contact data, phonebook data, messages, pictures, videos, etc. The memory 304 may be implemented using any type of volatile or non-volatile memory devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 306 provides power to various components of the apparatus 300. The power component 306 may include a power management system, one or more power sources, and any other components associated with the generation, management, and distribution of power in the apparatus 300.

The multimedia component 308 includes a screen providing an output interface between the apparatus 300 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 308 includes a front camera and/or a rear camera. The front camera and/or the rear camera may receive external multimedia data while the apparatus 300 is in an operation mode, such as a photographing mode or a video mode. Each of the front camera and the rear camera may be a fixed optical lens system or have focus and optical zoom capability.

The audio component 310 is configured to output and/or input audio signals. For example, the audio component 310 includes a microphone (MIC) configured to receive an external audio signal when the apparatus 300 is in an operation mode, such as a call mode, a recording mode, and a voice recognition mode. The received audio signal may be further stored in the memory 304 or transmitted via the communication component 316. In some embodiments, the audio component 310 further includes a speaker to output audio signals.

The I/O interface 312 provides an interface between the processing component 302 and peripheral interface modules, such as a keyboard, a click wheel, buttons, and the like. The buttons may include, but are not limited to, a home button, a volume button, a starting button, and a locking button.

The sensor component 314 includes one or more sensors to provide state assessments of various aspects of the apparatus 300. For instance, the sensor component 314 may detect an open/closed state of the apparatus 300, relative positioning of components, e.g., the display and the keypad of the apparatus 300, a change in position of the apparatus 300 or a component of the apparatus 300, a presence or absence of user contact with the apparatus 300, an orientation or an acceleration/deceleration of the apparatus 300, and a change in temperature of the apparatus 300. The sensor component 314 may include a proximity sensor configured to detect the presence of nearby objects without any physical contact. The sensor component 314 may also include a light sensor, such as a CMOS or CCD image sensor, for use in imaging applications. In some embodiments, the sensor component 314 may also include an acceleration sensor, a gyroscope sensor, a magnetic sensor, a pressure sensor, or a temperature sensor.

The communication component 316 is configured to facilitate communication, wired or wirelessly, between the apparatus 300 and other devices. The apparatus 300 can access a wireless network based on a communication standard, such as WiFi, 2G or 3G, or a combination thereof. In an embodiment, the communication component 316 receives a broadcast signal or broadcast associated information from an external broadcast management system via a broadcast channel. In an embodiment, the communication component 316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment, the apparatus 300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

In an embodiment, there is also provided a non-transitory computer-readable storage medium including instructions, such as the memory 304 including instructions, executable by the processor 320 in the apparatus 300, for completing the above methods. For example, the non-transitory computer-readable storage medium may be a ROM, a random access memory (RAM), a CD-ROM, a magnetic tape, a floppy disc, an optical data storage device, and the like.

FIG. 15 is a block diagram of a communication apparatus shown according to an embodiment. For example, apparatus 400 may be provided as a network device. Referring to FIG. 15, the apparatus 400 includes a processing component 422, which further includes one or more processors, and a memory resource represented by a memory 432 for storing an instruction executable by processing component 422, such as an application program. The application program stored in memory 432 may include one or more modules, each corresponding to a set of instructions. Furthermore, the processing component 422 is configured to execute instructions to perform the above-described method.

The apparatus 400 may further include a power supply component 426 configured to perform power management of the apparatus 400, a wired or wireless network interface 450 configured to connect the apparatus 400 to a network, and an input/output (I/O) interface 458. The apparatus 400 may operate based on an operating system stored in the memory 432, such as a Windows Server™, a Mac OS X™, a Unix™, a Linux™, a FreeBSD™, or the like.

In an embodiment, a non-transitory computer-readable storage medium including instructions is also provided, such as the memory 432 including instructions. The instructions are executable by the processing component 422 of the apparatus 400 to perform the above-described method. For example, the non-transitory computer-readable storage medium may be a ROM, random access memory (RAM), CD-ROM, magnetic tape, floppy disk, optical data storage device, or the like.

It may be further understood that, in the present disclosure, “a plurality of” means two or more than two, and other quantifiers are similar thereto. “And/or” describes the association relationship of associated objects, which indicates that three relationships may exist. For example, A and/or B may represent: A exists alone, A and B exist at the same time, and B exists alone. The character “/” generally indicates that the associated objects before and after are in an “or” relationship. The singular forms of “a”, “the” and “said” are also intended to include the plural forms, unless otherwise clearly indicated by the context.

It may be further understood that the terms “first”, “second”, etc. are used to describe various information, but such information should not be limited to these terms. These terms are only used to distinguish information of the same type from each other, and do not indicate a specific order or degree of importance. In fact, the expressions “first”, “second”, etc. can be used interchangeably. For example, without departing from the scope of the present disclosure, the first information can also be referred to as the second information, and similarly, the second information can also be referred to as the first information.

It can be further understood that, although the operations are described in a specific order in the drawings in the embodiments of the present disclosure, it should not be construed as requiring the operations to be performed in the specific order shown or in a sequential order, nor as requiring the execution of all the operations shown to obtain the desired result. In certain environments, multitasking and parallel processing may be advantageous.

Those skilled in the art will readily appreciate other implementation solutions of the present disclosure after considering the specification and practicing the disclosure disclosed herein. The present disclosure is intended to cover any variations, uses or adaptations of the present disclosure that follow the general principles of the present disclosure and include common knowledge or customary technical means in the art that are not disclosed in the present disclosure.

It should be understood that the present disclosure is not limited to the exact structures that have been described above and shown in the accompanying drawings, and various modifications and changes may be made without departing from the scope thereof. The scope of the present disclosure is limited only by the appended claims.

1. A communication method, performed by a terminal, comprising:
in response to the terminal switching from a first communication mode to a second communication mode, determining configuration information of the second communication mode;
wherein the first communication mode is a communication mode based on an artificial intelligence (Al) mode, and the second communication mode is a communication mode based on a non-Al mode.

2. (canceled)

3. The method according to claim 1, wherein determining the configuration information of the second communication mode comprises:
determining the configuration information of the second communication mode based on a first rule;
wherein the first rule comprises at least one of:
the configuration information of the second communication mode being the configuration information of the second communication mode before the terminal enters the first communication mode; or
the configuration information of the second communication mode being the configuration information of the second communication mode when the terminal accesses a network device.

4. The method according to claim 1, wherein determining the configuration information of the second communication mode comprises:
determining the configuration information of the second communication mode based on first information;
wherein the first information comprises at least one of:
configuration information of a single second communication mode; or
configuration information of multiple second communication modes.

5. The method according to claim 4, wherein the first information comprises the configuration information of the multiple second communication modes, and determining the configuration information of the second communication mode based on the first information comprises:
receiving first indication information, wherein the first indication information indicates configuration information of one second communication mode from the configuration information of the multiple second communication modes; and
determining the configuration information of the second communication mode based on the first indication information.

6. The method according to claim 5, wherein the first indication information further indicates the terminal to switch from the first communication mode to the second communication mode.

7. The method according to claim 1, further comprising:
receiving second indication information, wherein the second indication information indicates the terminal to switch from the first communication mode to the second communication mode.

8. The method according to claim 1, wherein determining the configuration information of the second communication mode comprises:
receiving third indication information, wherein the third indication information indicates the terminal to switch from the first communication mode to the second communication mode, and the third indication information configures the configuration information of the second communication mode; and
determining the configuration information of the second communication mode based on the third indication information.

9. The method according to claim 8, wherein the third indication information configures first configuration information of the second communication mode;
wherein determining the configuration information of the second communication mode based on the third indication information comprises:
determining the configuration information of the second communication mode based on the first configuration information and second configuration information, wherein the second configuration information is pre-configured by a network device.

10. (canceled)

11. The method according to claim 9, wherein the first configuration information is carried in physical layer signaling, and the second configuration information is carried in higher-layer signaling.

12. A communication method, performed by a network device, comprising:
determining configuration information of a second communication mode of a terminal, wherein the configuration information of the second communication mode is configuration information used by the terminal after switching from a first communication mode to the second communication mode;
wherein the first communication mode is a communication mode based on an artificial intelligence (Al) mode, and the second communication mode is a communication mode based on a non-Al mode.

13. (canceled)

14. The method according to claim 12, wherein determining the configuration information of the second communication mode comprises:
determining the configuration information of the second communication mode based on a first rule;
wherein the first rule comprises at least one of following:
the configuration information of the second communication mode being the configuration information of the second communication mode before the terminal enters the first communication mode; or
the configuration information of the second communication mode being the configuration information of the second communication mode when the terminal accesses the network device.

15. The method according to claim 12, wherein determining the configuration information of the second communication mode comprises:
determining the configuration information of the second communication mode based on first information;
wherein the first information comprises at least one of:
configuration information of a single second communication mode; or
configuration information of multiple second communication modes.

16. The method according to claim 15, wherein the first information comprises the configuration information of the multiple second communication modes, and the method further comprises:
sending first indication information, wherein the first indication information indicates the configuration information of one second communication mode from the configuration information of the multiple second communication modes.

17. The method according to claim 16, wherein the first indication information further indicates the terminal to switch from the first communication mode to the second communication mode.

18. The method according to claim 12, further comprising:
sending second indication information, wherein the second indication information indicates the terminal to switch from the first communication mode to the second communication mode.

19. The method according to claim 12, further comprising:
sending third indication information, wherein the third indication information indicates the terminal to switch from the first communication mode to the second communication mode, and the third indication information configures to configure the configuration information of the second communication mode.

20. The method according to claim 19, wherein the third indication information configures first configuration information of the second communication mode;
wherein the network device pre-configures second configuration information of the second communication mode.

21. (canceled)

22. The method according to claim 20, wherein the first configuration information is carried in physical layer signaling, and the second configuration information is carried in higher-layer signaling.

23. (canceled)

24. (canceled)

25. A communication apparatus, comprising:
a processor; and
a memory, configured to store processor-executable instructions;
wherein the processor is configured to:
in response to the terminal switching from a first communication mode to a second communication mode, determine configuration information of the second communication mode; wherein the first communication mode is a communication mode based on an artificial intelligence (Al) mode, and the second communication mode is a communication mode based on a non-Al mode.

26. A communication apparatus, comprising:
a processor; and
a memory, configured to store processor-executable instructions;
wherein the processor is configured to perform the communication method according to claim 12

27. (canceled)

28. (canceled)
